(19) United States
(12) Patent Application Publication
(10) Pub. No.: US 2008/0184350 A1
(43) Pub. Date: Jul. 31, 2008

(54) METHOD AND TERMINAL OF VERIFYING MEMBERSHIP FOR MOVING RIGHTS OBJECT IN DOMAIN

(75) Inventor: Youn-Sung CHU, Seoul (KR)

Correspondence Address: BIRCH STEWART KOLASCH & BIRCH, PO BOX 747, FALLS CHURCH, VA, 22040-0747, US

(73) Assignee: LG Electronics, Inc., Seoul (KR)

(21) Appl. No.: 11/849,100

(22) Filed: Aug. 31, 2007

Related U.S. Application Data
(60) Provisional application No. 60/842,645, filed on Sep. 7, 2006.

(30) Foreign Application Priority Data
Jul. 12, 2007 (KR) 10-2007-0070289

(51) Int. Cl. H04L 9/32; G06F 21/00

(52) U.S. Cl. 726/7

(57) ABSTRACT

Disclosed is a Digital rights Management (DRM), and particularly a method and terminal for verifying membership in order to move Rights Object (RO) in a domain, the method implemented in a first embodiment in which a second device calculates a MAC value as a verified value to send to a first device before the first device moves a domain RO to the second device, and accordingly the first device verifies that the second device is a properly subscribed domain member to thereafter move the domain RO, and a second embodiment in which when the first device calculates a first verified value to send to a second device, the second device verifies whether the first device is a properly subscribed domain member and then calculates a second verified value to send to the first device, and the first device also verifies whether the second device is a properly subscribed domain member to thereafter send the domain RO to the second device. The present invention allows the domain RO to be moved in the domain only between devices which properly belong to the domain, such that a problem in security, which may occur when moving the domain RO without verifying whether a device to receive the domain RO moved is the properly subscribed domain member upon the movement of the domain RO between the devices, can be avoided.

This Nonprovisional application claims priority under 35 U.S.C. § 119(e) on U.S. Provisional Application Nos. 60/842,645 filed on Sep. 7, 2006, and claims priority under 35 U.S.C. § 119(a) on Patent Application No(s). 10-2007-0070289 filed in Republic of Korea, on Jul. 12, 2007, the entire contents of which are hereby incorporated by reference.

### TECHNICAL FIELD

The present invention relates to a Digital Rights Management (DRM), and more particularly, to a method and terminal for verifying whether or not a device to which Rights Object (RO) is to be moved is a properly subscribed (allowable, authorized) member of the domain before moving the RO and content between devices in the domain.

### RELATED ART

A Digital Rights Management (DRM) refers to a system technology for safely protecting rights for digital contents and systematically managing them. The DRM provides a protecting and managing scheme for preventing the illegal copy of a content, acquiring DRM contents RO, and generating and transferring the content.

FIG. 1 illustrates a construction of a typical DRM system. The DRM system controls content issued to a user by a content provider to be used only in a right-limit of RO. Here, the content provider refers to an entity corresponding to a Content Issuer (CI) and/or a Rights Issuer (RI).

The CI issues a protected content (hereinafter, referred to as DRM content) using a particular encryption key so as to protect the content from users having no access right therefor, while the RI issues RO required to use the protected content.

A DRM agent is mounted in a device thus to receive contents and their ROs from the CI and the RI, respectively. The DRM agent then analyzes (interprets) permission and/or constraint included in the ROs, thereby controlling the use of contents in the device.

FIG. 2 is a flowchart illustrating a procedure of transferring a domain RO between members (devices, users) joined in a user domain according to the related art.

In the related art, a device 1 performs a process of transferring an RO received from the RI to a device 2 through a Move Domain RO Request procedure and a Move Domain RO Response procedure, and sending the contents (DRM content format(DCF)) received from the CI to the device 2. However, in this process, the domain RO movement is allowed to be performed without any confirmation as to whether a receiver device is a properly subscribed member of the user domain, resulting in an occurrence of a security relevant problem.

Accordingly, even when the receiver device is not the member of the corresponding user domain, the domain RO may be transferred to the device 2. Several cases where the domain RO may not be securely protected are as follows.

In a first case, when the device 1 moves the domain RO to the device 2 and transfers the protected contents (DCF) thereto and thereafter deletes the domain RO, if the device 2 has not joined the domain, the device 1 within the user domain no longer has the domain RO, and thus, the device 1 can not reproduce the contents, while the device 2 can not reproduce the contents because, although it has the domain RO, it is not a member of the domain.

When this case occurs, since any member within the domain does not have the RO for the corresponding content, in order to use the content, any of the domain members should inconveniently access the RI again to acquire a newly issued domain RO therefrom.

The second case relates to a malicious device that receives the domain RO. If the malicious device receives the domain RO and the domain RO is moved, the domain RO can not be moved among properly subscribed domain members.

The third case relates to when the device 2 having received the domain RO from the device 1 is not the member of the domain, but is a device which attacks to obtain a domain key and Content Encryption Key(CEK). The device 2 may attempt to obtain the domain key and CEK using the moved domain RO. In this case, the device 2 already knows the encrypted domain RO and an encryption algorithm, and accordingly may attempt a brute-force attack.

### SUMMARY OF THE INVENTION

One aspect of the present invention involves the recognition by the present inventors of the drawbacks in the related art, as explained above. Based upon such recognition, improvements in verifying whether or not a device to which Rights Object (RO) is to be moved is a properly subscribed member of the domain before moving the RO and content between devices in the domain.

Certain features that may be part of the DRM system and device using digital rights with verifying process described above will not be described in much detail, merely to prevent the characteristics of the present invention from being obscured. However, such additional features may also be part of the DRM system and device using digital rights with such verifying process, as would be understood by those skilled in the art.

Therefore, it is an object of the present invention to provide a method and terminal for verifying membership in order to move RO in a domain between devices whereby it can be verified whether a target device with/to which a domain RO is shared/moved is a device rightly joined in a user domain.

To achieve these objects, there is provided a method for verifying membership in order to move RO in a domain comprising: sending, by a first device, an authentication request message to a second device; receiving, by the first device, an authentication response message including a verified value with respect to the authentication request thereof from the second device; and verifying, by the first device, whether the second device is a properly subscribed domain member (user).

In another aspect of the present invention, a method of verifying membership for moving RO in a domain the method performed by the first device comprising: sending an authentication request message from the first device to a second device; receiving, from the second device, an authentication response message including a verified value in response to the authentication request message; and verifying whether the second device is a properly subscribed member of the domain by using the received authentication response message.

In another aspect of the present invention, a method of verifying membership for moving RO in a domain a mutual verification process, the method comprising: verifying, by a first device, whether a second device is a properly subscribed member of the domain by receiving an authentication request message, wherein the authentication request message includes a first verified value; and re-verifying, by the second device, whether the first device is a properly subscribed member of the domain by receiving an authentication response message in response to the authentication request message, wherein the authentication response message includes a second verified value.

In another aspect of the present invention, a method of verifying membership for moving RO in a domain, the method performed by a first device comprising: sending a first request message to a first entity in order to request a domain member list; receiving a first response message including the domain member list from the first entity; and checking whether a particular device is a properly subscribed domain member using the received domain member list, wherein the particular device will be received a RO from the first device.

In another aspect of the present invention, a method of verifying membership for moving RO in a domain, the method performed by a first device comprising: sending, the first device to a first entity, a first request message for verifying whether a second device is a subscribed member of the domain; receiving, from the first entity, a first response message including a domain member verification result with respect to the second device; and checking the domain member verification result with respect to the second device.

In another aspect of the present invention, a method of verifying membership for moving RO in a domain, the method comprising: calculating, by a second device, a verified value after receiving an authentication request message from a first device; and sending an authentication response message including the verified value to the first device thereby allowing the first device for verifying whether the second device is a properly subscribed domain member.

In another aspect of the present invention, a method of verifying membership for moving RO in a domain, the method comprising: receiving, by a second device, an authentication request message including a first verified value calculated by a first device so as to verify whether the first device is a properly subscribed domain member; calculating, by the second device, a second verified value using a domain key; and sending, by the second device, an authentication response message including the second verified value to the first device such that the first device verifies whether the second device is a properly subscribed domain member.

In an aspect of the present invention, a terminal for verifying membership in order to move RO in a domain the terminal comprising: a first entity adapted to manage a domain registration and a domain subscription; a second entity adapted to issue a domain key and a domain Right Object (RO) and to provide a content; a first device adapted to receive the domain key, the domain RO and the content from the second entity, wherein the first device is registered and subscribed via the first entity; and a second device adapted to receive the domain RO and the content from the first device if the second device is verified as a properly subscribed domain member by the first device.

### BRIEF DESCRIPTION OF THE DRAWINGS

FIG. 1 is an exemplary construction of a typical DRM system.

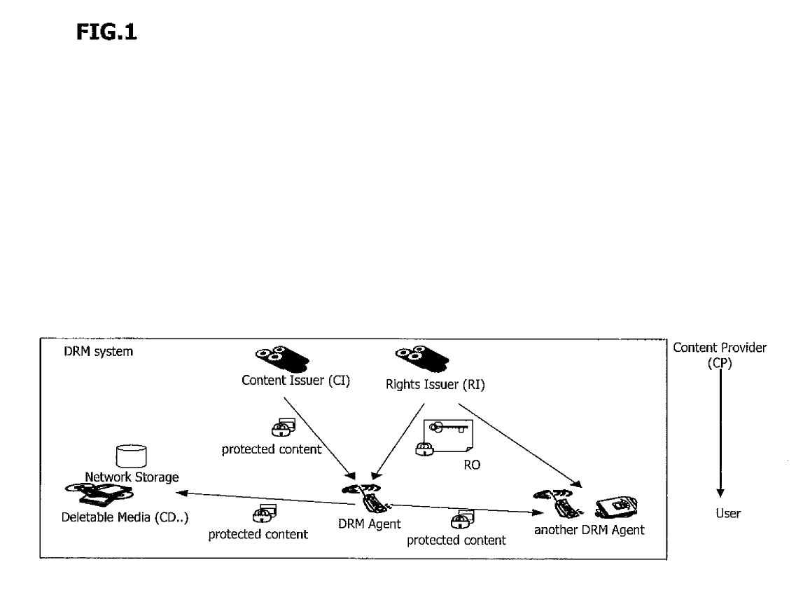

FIG. 2 is a signal flowchart illustrating a procedure of transferring a domain RO between members in a user domain according to the related art.

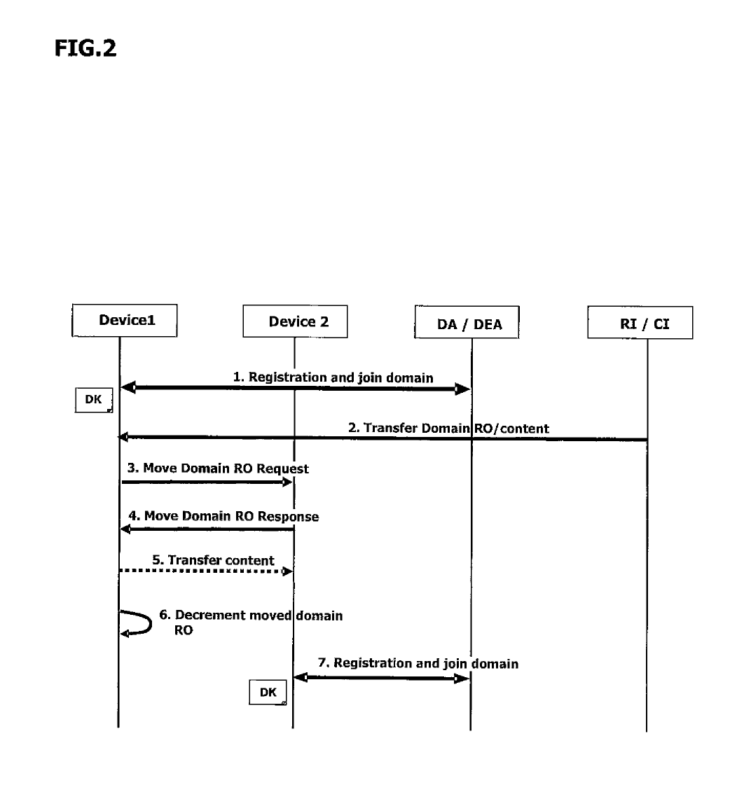

FIG. 3 is a signal flowchart illustrating a method of verifying membership for moving a domain RO in accordance with a first embodiment of the present invention.

FIG. 4 is a signal flowchart illustrating a method of verifying membership for moving a domain RO in accordance with a second embodiment of the present invention.

FIG. 5 is a signal flowchart illustrating a method of verifying membership for moving a domain RO in accordance with a third embodiment of the present invention.

FIG. 6 is a signal flowchart illustrating a method of verifying membership for moving a domain RO in accordance with a fourth embodiment of the present invention.

### MODES FOR CARRYING OUT THE PREFERRED EMBODIMENTS

The present invention is applied to a DRM system and device using digital rights. However, the present invention may be applied to other wired/wireless communications.

The present invention conceptually relates to a method for verifying whether a target device to receive a domain RO is a properly subscribed domain member (device, user) by calculating a MAC value as a verified value using a domain key obtained from a Rights Issuer (RI) before sharing or moving the domain RO between devices in a domain. Thus, the present invention can be applied to every technology related to Ad Hoc share as well as RO movement in a general domain including a user domain.

The present invention can be implemented in four embodiments as follows.

First, in a first embodiment, before moving a domain RO from a first device to a second device in a user domain, the second device calculates a verified value (i.e., MAC value) to send it to the first device, and accordingly the first device moves the domain RO to the second device after verifying whether the second device is the properly subscribed member of the user domain.

In a second embodiment, when a first device calculates a first verified value to send it to the second device, the second device verifies based upon the first verified value whether the first device is the properly subscribed member (device, user). When the second device then calculates a second verified value to send it to the first device, the first device verifies based upon the received second verified value whether the second device is the properly subscribed member. After this mutual verification, the first device moves a domain RO to the second device.

In a third embodiment, when a first device requests a domain member list from a first entity (i.e., DA/DEA) in order to check entire members (devices, users) of a user domain, the first entity encrypts a user domain member list including a white list and a black list of members belonging to the user domain and then sends the encrypted user domain member list to the first device. The first device checks the received user domain member list. The first device then moves a domain RO to the second device when the second device is verified as a properly subscribed member of the user domain.

In a fourth embodiment, when a first device sends a membership check request message to a first entity (i.e., DA/DEA), the first entity verifies (checks) whether a second device is the member of a user domain and then notifies the first device of the verification (check) result. Accordingly, the first device can confirm whether the second device is the properly subscribed member.

Technical terms used in the present invention are briefly described as follows.

A device according to the present invention may be commonly referred to as a terminal, which includes every terminal capable of using digital contents. That is, the device according to the present invention, namely, the terminal may include mobile communication terminals capable of using VCC services (e.g., user equipment (UE), mobile phones, cellular phones, DMB phones, DVB-H phones, PDA phones, PTT phones, etc.), digital TVs, GPS navigation, portable game players, MP3, other home electronics and the like. Therefore, the device may be used as the same as the terminal in the present invention. Also, the device according to the present invention may internally include a communication module, a Web/WAP browser, a DRM agent, a media player and library and a memory.

Hereinafter, constructions and operations of embodiments of a method for verifying membership in order to move RO in a user domain in a Digital Rights Management (DRM) according to the present invention will be described with reference to the accompanying drawings.

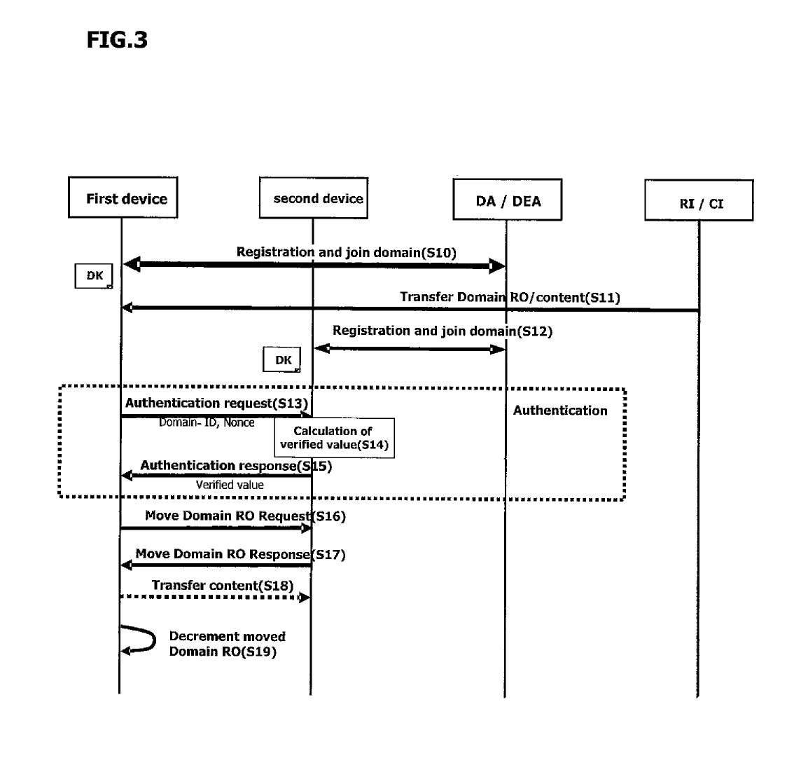

FIG. 3 is a signal flowchart illustrating an authentication procedure of verifying whether a target device to which a domain RO is to be moved is a member (user) of a user domain before moving the domain RO in the user domain.

In case where a target device to which a domain RO is to be moved has a domain key of a user domain, the device is considered as the member of the (user) domain. Also, for the secure movement of the domain RO, the movement is permitted only between devices which are members of the user domain.

First, a DRM agent of a first device (hereafter, referred to as ‘first device’) registers in a first entity (i.e., DA/DEA) in order to obtain a domain RO and a content and joins in a corresponding user domain (S10).

The registration process should be re-performed upon the expiration of period. The device joined in the user domain receives a domain KEY allocated from a Rights Issuer (RI).

After completely performing the registration and join process, the first device accesses the RI or the first entity to receive a domain RO and may get a protected content (DCF) from a Contents Issuer (CI) (S11). Here, the domain RO can be provided to devices which have joined in the user domain.

In addition, a DRM agent of a second device (hereafter, referred to as ‘second device’) registers in the first entity (i.e., DA/DEA) and joins in the corresponding user domain as a member (S12).

As described above, after the registration and join process of the first and second devices is completely performed, the first device sends an authentication request message to the second device to receive the domain RO in order to verify whether the second device is the member of the user domain (S13). Here, the first device may send the authentication request message by including a domain ID to which it belongs and Nonce (an arbitrarily selected random value). The Nonce may provide freshness of a verified value (verification value) at the following process.

Also, the authentication request message may additionally include the first device ID used for checking a device sending the domain RO.

After receiving the authentication request message, the second device calculates a verified value for notifying that it is the properly subscribed member of the user domain (S14). The verified value allows the second device to be verified as the properly subscribed member having the domain ID. If the second device is the properly subscribed member, it has a domain key of the corresponding domain. Accordingly, the second device can calculate the verified value.

The verified value calculation is done as follows.

Verified value==HMAC−SHA1_{DK}(Domain−ID+Nonce)or

Verified value=SHA1(DK+DomainID+Nonce)

where ‘Nonce’ denotes an arbitrarily selected random value, ‘+’ denotes concatenation of each value and ‘DK’ denotes a domain key.

Also, ‘HMAC-SHA1_{DK}(message)’ denotes an algorithm for calculating a hashed MAC value using a domain key.

Upon the calculation of the verified value, the second device sends an authentication response message including the calculated verified value to the first device (S15).

The first device may determines whether the verified value included in the received authentication response message is the same as the verified value calculated using its domain key.

If the verified value sent by the second device is the same as the verified value calculated by the first device, the first device may determines the second device to be the properly subscribed member and then may sends a Move Domain RO Request message to the second device so as to move the domain RO to the second device (S16).

After the domain RO is moved from the first device to the second device, the second device sends a Move Domain RO Response message to the first device so as to notify the first device of the result of the domain RO movement (S17).

Upon completely moving the domain RO to the second device, the first device may send a protected content (DCF) to the second device (S18).

Here, the domain RO of the first device may be decreased (decremented) by the amount of the RO moved. That is, for Stateless RO, the RO is deleted from the first device, while for Stateful RO, the RO of the first device is decreased by the amount of the RO moved (S19).

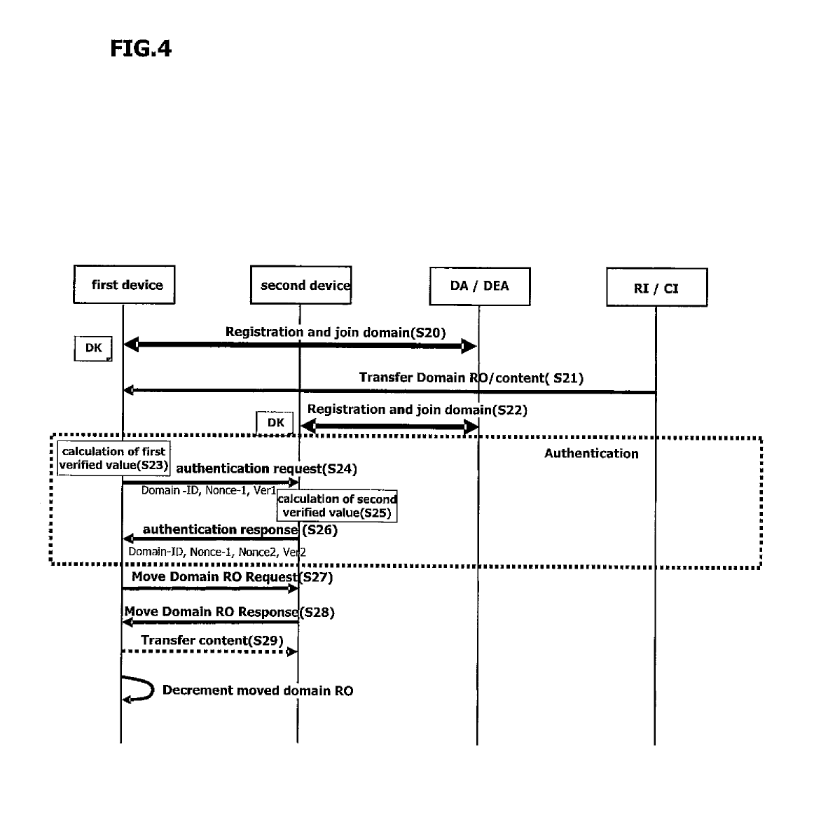

FIG. 4 is a signal flowchart illustrating a mutual verification procedure of verifying membership in a user domain before moving a domain RO in the user domain in accordance with a second embodiment of the present invention.

First and second devices performs a mutual verification to verify whether a target device to receive a domain RO moved is a member of a user domain as shown in FIG. 4.

First, the first device registers in a first entity (i.e., DA/DEA) to obtain a domain RO and a content and joins in the corresponding user domain (S20).

The registration process should be re-performed upon the expiration of period. The device joined in the user domain receives a domain KEY allocated from a Rights Issuer (RI) or the first entity.

After completely performing the registration and join process, the first device accesses the RI or the first entity to receive a domain RO and may get a protected content (DCF) from a Contents Issuer (CI) (S21). Here, the domain RO can be provided to devices which have joined in the user domain.

In addition, the second device registers in the first entity (i.e., DA/DEA) and joins in the corresponding user domain as a member (S22).

As described above, after the registration and join process of the first and second devices is completely performed, the first device calculates a first verified value using its domain key in order to notify the second device that it is the allowable member of the user domain (S23).

The first verified value is calculated as follows.

Verified value1==HMAC−SHA1_{DK}(Domain−ID+Nonce−1)or

Verified value1=SHA1(DK+DomainID+Nonce−1)

where ‘Nonce’ denotes an arbitrarily selected random value, ‘+’ denotes concatenation of each value, and ‘DK’ denotes a domain key.

Also, ‘HMAC-SHA1_{DK} (message)’ denotes an algorithm used for calculating a hashed MAC value using a domain key.

The first device sends an authentication request message to the second device to check whether the second device is the member of the user domain (S24).

Here, the first device sends the authentication request message by including a domain ID to which it belongs, Nonce-1 as an arbitrarily selected random value, the calculated first verified value and the like.

Here, the Nonce-1 may provide freshness of the first verified value.

Also, the authentication request message may further include a first device ID to check the device which sends the message.

After receiving the authentication request message, the second device compares the first verified value sent by the first device with a MAC value directly calculated by itself using its domain key for verification. Thereafter, if the first verified value is the same as the MAC value calculated by the second device and accordingly it is verified that the first device is the properly subscribed member, then the second device calculates a second verified value in order to verify that it is the properly subscribed member of the user domain (S25).

If the second device is the properly subscribed member, it has a domain key of the corresponding domain. Accordingly, the second device can calculate the second verified value.

The second verified value is calculated as follows.

Verified value2=HMAC−SHA1_{DK}(Domain−ID+Nonce−1+Nonce−2)or

Verified value2=SHA1(DK+Domain−ID+Nonce−1+Nonce-2)

where ‘Nonce-1’ denotes a random value sent by the first device, ‘Nonce-2’ denotes a random value generated by the second device, ‘+’ denotes concatenation of each value, and ‘DK’ denotes a domain key.

Also, ‘HMAC-SHA1_{DK} (message)’ denotes an algorithm used for calculating a hashed MAC value using the domain key.

After calculating the second verified value, the second device sends an authentication response message including the calculated second verified value to the first device (S26).

The first device checks whether the second verified value included in the received authentication response message is the same as the MAC value calculated by itself using its domain key.

If the second verified value sent by the second device is the same as the MAC value calculated by the first device, the first device determines the second device to be the properly subscribed member and then sends a Move Domain RO Request message to the second device, thereby moving the domain RO to the second device (S27).

After the domain RO is moved from the first device to the second device, the second device sends a Move Domain RO Response message to the first device, thereby notifying a result of the domain RO movement to the first device(S28).

After completely performing the domain RO movement, the first device may send a protected content to the second device (S29).

Here, the domain RO of the first device may be decreased (decremented) by the amount of the RO moved. That is, for Stateless RO, the RO is deleted from the first device, while for Stateful RO, the RO of the first device is decreased by the amount of the RO moved.

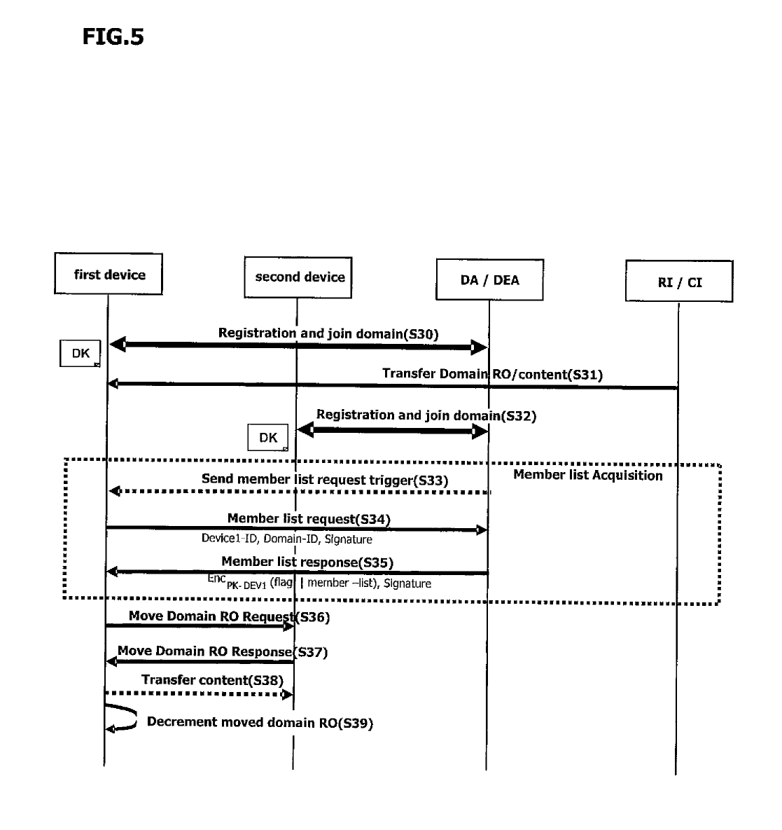

FIG. 5 is a signal flowchart illustrating a method for verifying membership in a domain in accordance with a third embodiment of the present invention in which before moving a domain RO in a user domain, a first device receives a list of members belonging to the user domain issued by a DA to verify whether a device to receive the domain RO is a properly subscribed member and then moves the domain RO only to the properly subscribed domain member.

First, the first device registers in a first entity (i.e., DA/DEA) to obtain a domain RO and a content and joins in the corresponding user domain (S30).

The registration process should be re-performed upon the expiration of period. The device joined in the user domain receives a domain KEY allocated from a Rights Issuer (RI).

After completely performing the registration and join process, the first device accesses the RI to receive a domain RO and may get a protected content (DCF) from a Contents Issuer (CI) (S31). Here, the domain RO can be provided to devices which have joined in the user domain.

In addition, the second device registers in the first entity (i.e., DA/DEA) and joins in the corresponding user domain as a member (S32).

In this state, the DA/DEA selectively sends a trigger signal for requesting a member list to the first device (S33).

The trigger signal may be generated when members in the user domain are changed in numbers or the like or updated periodically.

The first device then sends a message for requesting a member list of the user domain to the DA/DEA in order to verify whether the second device is the properly subscribed member before moving the domain RO to the second device (S34).

The member list request message of the first device may include a first device ID, a domain ID, a signature for an entire message, and the like.

The first device ID is used for checking whether a device requesting the list of entire members of the user domain is a member of the user domain, the domain ID is used for checking the corresponding user domain, and the signature is used for checking impurity of messages and a sender device.

The DA/DEA checks the received member list request message. If it is checked that the first device is the member of the user domain based upon the first device ID, the DA/DEA encrypts white list and black list of members belonging to the corresponding user domain using a public key of the first device and then sends the encrypted white and black lists to the first device together with a member list response message (S35).

Here, the white list denotes a list of properly subscribed members (devices) belonging to the domain while the black list denotes a list of members which were domain members but have left the domain or a list of members which are not normal domain members such as members hacked by an external attack.

The white and black lists may be discriminated based upon a flag value as an encrypted parameter of the member list response message. For example, the white list has flag value=‘1’, while the black list has flag value=‘0’.

The member list may include information used for checking a user domain member such as a device ID belonging to the corresponding user domain or the like. The member list may also include a signature (e.g., a digital signature etc.) for checking a member list sent by the DA/DEA. If not including the signature, an attacker may encrypt a counterfeit member list using the public key of the first device to sent to the first device.

In addition, a parameter may selectively be set (provided) in order to indicate whether the second device want to expose its ID. Also, a process of checking whether privacy of the second device is activated may be performed based upon the such indication.

For example, a status code or the like may be used for informing whether the privacy has been activated.

The first device checks the user domain member list included in the member list response message. If the second device is verified as a properly subscribed member, the first device sends a Move Domain RO Request message to the second device to perform the domain RO movement (S36).

If the second device is not verified as the user domain member, the first device terminates the process of moving the domain RO.

When the domain RO is moved from the first device to the second device, the second device sends a Move Domain RO Response message to the first device to inform the result of the domain RO movement (S37).

After completely moving the domain RO, the first device may send a protected content to the second device (S38).

Here, the domain RO of the first device may be decreased (decremented) by the amount of the RO moved. That is, for Stateless RO, the RO is deleted from the first device, while for Stateful RO, the RO of the first device is decreased by the amount of the RO moved (S39).

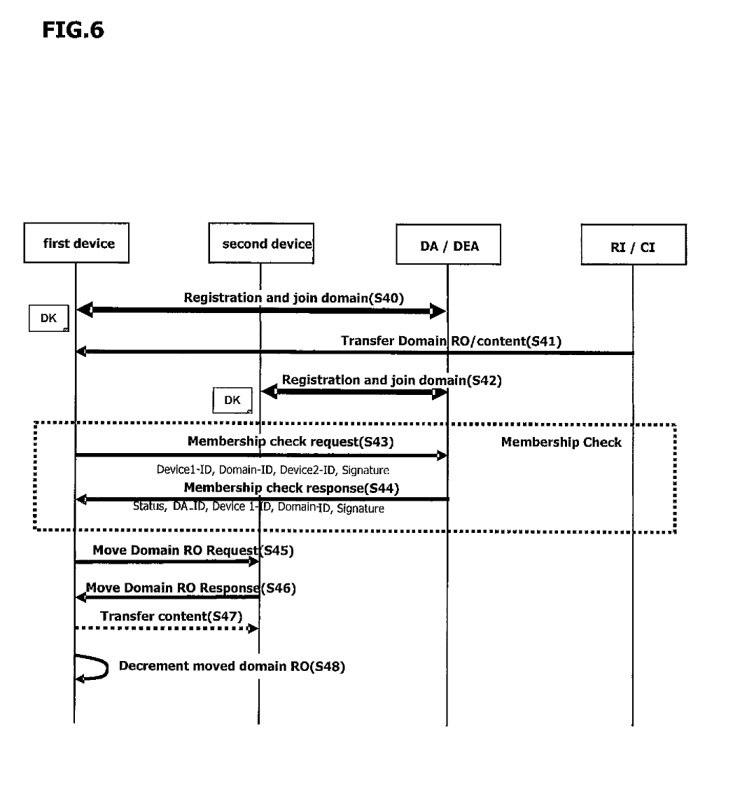

FIG. 6 is a signal flowchart illustrating a membership check procedure of verifying whether a second device to receive a domain RO is a member of a user domain before moving the domain RO in the user domain in accordance with a fourth embodiment of the present invention.

First, the first device registers in a DA/DEA as a first entity for acquiring domain RO and content and joins in the corresponding user domain (S40).

The registration process should be re-performed upon the expiration of period. The device joined in the user domain receives a domain KEY allocated from a Rights Issuer (RI) or the first entity.

After completely performing the registration and join process, the first device accesses the RI to receive a domain RO and get a protected content (DCF) from a Contents Issuer (CI) (S41). Here, the domain RO can be provided to devices which have joined in the user domain.

In addition, the second device registers in the first entity (i.e., DA/DEA) and joins in the corresponding user domain as a member (S42).

In this state, the first device sends to the DA/DEA a membership check request message for requesting check as to whether the second device is the properly subscribed member before moving the domain RO to the second device (S43).

Here, the first device may send the membership check request message by including a first device ID, a user domain ID to which it belongs, a second device ID and a signature for an entire message.

Accordingly, the DA/DEA verifies whether the second device is the member of the user domain according to the member list (e.g., a member ID list). Then, the DA/DEA may send a membership check response message including a Status, which indicates a verification result of the membership to the first device (S44).

The membership check response message may include an ID of the DA/DEA, the first device ID, the domain ID and the signature of an entire message.

The first device receives the membership check response message to check whether the second device is the properly subscribed member based upon the received Status. If the second device is verified as the properly subscribed member of the user domain, the first device sends a Move Domain RO Request message to the second device to move the domain RO thereto (S45).

If the second device is not verified as the properly subscribed member of the user domain, the first device terminates the procedure of moving the domain RO.

When the domain RO is moved from the first device to the second device, the second device sends a Move Domain RO Response message to the first device, thereby notifying a result of the domain RO movement to the first device(S46).

After completely moving the domain RO, the first device may send a protected content to the second device (S47).

Here, the domain RO of the first device may be decreased by an amount of a RO movement. This may be defined as a Stateful RO. Here, the domain RO of the first device may be deleted from the first device. This may be defined as a Stateless RO., while for Stateful RO, the RO of the first device is decreased by the amount of the RO moved (S48).

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

As described above, the present invention has been explained with reference to the embodiments which are merely exemplary. It will be apparent to those skilled in the art that various variations and equivalent embodiments can be made in the present invention without departing from the spirit or scope of the invention.

### EFFECT OF THE INVENTION

In accordance with the present invention, as a domain RO in a domain is allowed to be moved only when a device to receive the domain RO is a properly subscribed member of the domain, a security problem, which may occur when the domain RO can be moved (transferred) without any verification as to whether the device is the member of the domain, can be avoided.

Therefore, a device which is not the member of the domain can neither acquire the domain RO nor attempt to obtain a domain key and CEK.

1. A method of verifying membership for moving Rights Object (RO) in a domain, the method performed by a first device comprising:
sending an authentication request message from the first device to a second device;
receiving a authentication response message included verified value related the authentication request message; and
verifying whether the second device is a properly subscribed member of the domain by using the received authentication response message.

2. The method of claim 1, further comprising:
obtaining, by the first device, a domain key from a first entity; and
receiving, by the first device, at least of a domain Right Object (RO) or a content from a second entity.

3. The method of claim 2, wherein the first entity is Domain Authority/Domain Enforcement Agent(DA/DEA) and the second entity is at least of Rights Issuer (RI) or Contents Issuer (CI).

4. The method of claim 1, further comprising:
sending, from the first device to the second device, a Move Domain RO Request message that includes a domain RO; and
receiving, from the second device to the first device, a Move Domain RO Response message that indicates a result of a movement of the domain RO.

5. The method of claim 2, wherein the first device registers in the first entity and joins in a user domain to obtain a domain key.

6. The method of claim 1, wherein the verifying step, further comprising;
transmitting information from the first device to the second device;
receiving the authentication response message including the verified value which is calculated by the second device using the transmitted information; and
verifying whether the second device is the properly subscribed member of the domain by comparing the received verified value with a MAC value calculated by the first device.

7. The method of claim 6, wherein the authentication request message contains the information, which includes at least one of a domain ID, a random value and an first device Identification (ID).

8. The method of claim 6, wherein the verified value is calculated by
HMAC−SHA1_{DK}(Domain−ID+Nonce)or
SHA1(DK+DomainID+Nonce),
where ‘Nonce’ denotes an arbitrarily selected random value, ‘+’ denotes concatenation of each value, ‘DK’ denotes a domain key, and ‘HMAC-SHA1_{DK}(message)’ denotes an algorithm for calculating a hashed MAC value using the domain key.

9. A method of verifying membership for moving Rights Object (RO) in a domain through a mutual verification process, the method comprising:
verifying, by a first device, whether a second device is a properly subscribed member of the domain by receiving an authentication request message, wherein the authentication request message includes a first verified value; and
re-verifying, by the second device, whether the first device is a properly subscribed member of the domain by receiving an authentication response message in response to the authentication request message, wherein the authentication response message includes a second verified value.

10. The method of claim 9, further comprising:
obtaining, by the first device, a domain key from a first entity; and
receiving, by the first device, at least of a domain RO or a content from a second entity.

11. The method of claim 9, wherein the mutual verification process further comprising:
calculating, by the first device, the first verified value using first information;
sending, by the first device, the authentication request message including the calculated first verified value to the second device;
verifying, by the second device, the first verified value received from the first device to check whether the first device is the properly subscribed domain member;
calculating, by the second device, the second verified value using second information; and
sending, by the second device, the authentication response message including the calculated second verified value to the first device; and
comparing, by the first device, the second verified value with the first verified value thereby to verify whether the second device is the proper subscribed domain member.

12. The method of claim 9, wherein the first verified value is calculated by
HMAC−SHA1_{DK}(Domain−ID+Nonce−1)or
SHA1(DK+DomainID+Nonce−1),
where ‘Nonce-1’ denotes an arbitrarily selected random value, ‘+’ denotes concatenation of each value, ‘DK’ denotes a domain key, and ‘HMAC-SHA1_{DK} (message)’ denotes an algorithm for calculating a hashed MAC value using the domain key.

13. The method of claim 9, wherein the second verified value is calculated by
HMAC−SHA1_{DK}(Domain−ID+Nonce−1+Nonce−2)or
SHA1(DK+DomainID+Nonce−1+Nonce−2),
where ‘Nonce-1 and Nonce-2’ denote arbitrarily selected random values, ‘+’ denotes concatenation of each value, ‘DK’ denotes a domain key and ‘HMAC-SHA1_{DK} (message)’ denotes an algorithm for calculating a hashed MAC value using the domain key.

14. The method of claim 11, wherein the authentication request message, received by the second device from the first device, contains the first information, which includes at least one of a domain ID and a first random value, and the authentication response message, received by the first device from the second device, contains the second information, which includes at least one of a domain ID, a first random value and a second random value.

15. The method of claim 9, wherein the mutual verification process further comprising:
sending, by the first device, first information to the second device;
checking, by the second device, whether the first device is the properly subscribed domain member based upon a first electronic signature value included in the first information;
sending, by the second device, second information to the first device; and
checking, by the first device, whether the second device is the properly subscribed domain member based upon a second electronic signature value included in the second information.

16. The method of claim 15, wherein the first information comprises at least one of a domain ID, a first device ID, a random value and the first electronic signature value of an entire message calculated using a private key of the first device,
wherein the second information comprises at least one of a domain ID, a first device ID, a second device ID, a random value and the second electronic signature value of an entire message calculated using a private key of the first device.

17. The method of claim 9, wherein the mutual verification process further comprising:
sending, by the first device, first information to the second device;
checking, by the second device, whether the first device is the properly subscribed domain member based upon a first encrypted message for an entire message calculated using a domain key included in the first information;
sending, by the second device, second information to the first device; and
checking, by the first device, that the second device is the properly subscribed domain member based upon a second encrypted message for an entire message calculated using a domain key included in the second information.

18. The method of claim 17, wherein the first information comprises at least one of a domain ID, a first device ID, a random value and the first encrypted message of an entire message calculated using a private key of the first device,
wherein the second information comprises at least one of a domain ID, a first device ID, a second device ID, a random value, and the second encrypted message of an entire message calculated using a private key of the first device.

19. A method of verifying membership for moving Rights Object (RO) in a domain, the method performed by a first device comprising:
sending a first request to a first entity in order to request a domain member;
receiving a first response message including the domain member from the first entity; and
checking whether a particular device is a properly subscribed domain member using the received domain member, wherein the particular device will be received a RO from the first device.

20. The method of claim 19, further comprising:
Obtaining a domain key from the first entity; and
receiving a domain RO and a content from a second entity.

21. The method of claim 19, wherein the verification by the first device as to whether a device to which the RO is to be moved is a properly subscribed member of the domain is to check whether a device to which the RO is to be moved is a properly subscribed member based upon the domain member included in the first response message.

22. The method of claim 19, wherein the first request message is a domain member request message, which comprises at least one of a first device ID, a domain ID and a signature of an entire message.

23. The method of claim 19, wherein the first response message is a response message related the domain member which denotes an encrypted message using a public key of the first device, and the encrypted message includes a white list and a black list of members belonging to the domain.

24. The method of claim 23, wherein the white list includes properly subscribed members belonging to the domain,
wherein the black list includes members which were members of the domain but have left the domain currently or abnormal members hacked by an external attack,
wherein the white and black lists are discriminated according to a flag value as an encrypted parameter of the domain member list response message.

25. The method of claim 19, wherein the first request message of the first device is sent to the first entity by the first device after the first device receives a trigger signal for requesting the member from the first entity.

26. The method of claim 25, wherein the trigger signal sent from the first entity to the first device is generated when members in the domain are changed or periodically updated.

27. A method of checking membership for moving Rights Object (RO) in a domain, the method performed by a first device comprising:
sending, the first device to a first entity, a first request message for verifying whether a second device is a subscribed member of the domain;
receiving, from the first entity, a first response message including a domain member verification result with respect to the second device; and
checking the domain member verification result with respect to the second device.

28. The method of claim 27, further comprising:
obtaining a domain key from the first entity; and
receiving a domain RO and a content from a second entity.

29. The method of claim 27, wherein the first request message is a membership check request message for verifying whether the second device is the properly subscribed domain member, and the first request message includes at least one of a first device ID, a domain ID, a second device ID and a signature for an entire message.

30. The method of claim 27, wherein the first response message is a response message indicating the verification result as to whether the second device is the properly subscribed domain member, and the first response message includes at least one of a Domain Authority(DA) ID, a first device ID, a domain ID and a signature for an entire message.

31. A method of verifying membership for moving Rights Object (RO) in a domain, the method comprising:
extracting, by a second device, a verified value after receiving an authentication request message from a first device; and
sending an authentication response message including the verified is value to the first device thereby allowing the first device for verifying whether the second device is a properly subscribed domain member.

32. The method of claim 31, wherein the verified value is calculated by using a domain key obtained from a first entity.

33. A method of verifying membership for moving Rights Object (RO) in a domain, the method comprising:
receiving, by a second device, an authentication request message including a first verified value calculated by a first device so as to verify whether the first device is a properly subscribed domain member;
calculating, by the second device, a second verified value using a domain key; and
sending, by the second device, an authentication response message including the second verified value to the first device such that the first device verifies whether the second device is a properly subscribed domain member.

34. The method of claim 33, wherein the first verified value is calculated by
HMAC−SHA1_{DK}(Domain−ID+Nonce-1)or
SHA1(DK+DomainID+Nonce-1),
where ‘Nonce-1’ denotes an arbitrarily selected random value, ‘+’ denotes concatenation of each value, ‘DK’ denotes a domain key, and ‘HMAC-SHA1_{DK} (message)’ denotes an algorithm for calculating a hashed is MAC value using the domain key.

35. The method of claim 33, wherein the second verified value is calculated by
HMAC−SHA1_{DK}(Domain−ID+Nonce−1+Nonce−2)or
SHA1(DK+DomainID+Nonce−1+Nonce−2),
where ‘Nonce-1 and Noce-2’ denote arbitrarily selected random values, ‘+’ denotes concatenation of each value, ‘DK’ denotes a domain key and ‘HMAC-SHA1_{DK} (message)’ denotes an algorithm for calculating a hashed MAC value using the domain key.

36. A terminal for verifying membership in order to move Rights Object (RO) in a domain, the terminal comprising:
a first entity adapted to manage a domain registration and a domain subscription;
a second entity adapted to issue a domain key and a domain Right Object (RO) and to provide a content;
a first device adapted to receive the domain key, the domain RO and the content from the second entity, wherein the first device is registered and subscribed via the first entity; and
a second device adapted to receive the domain RO and the content from the first device if the second device is verified as a properly subscribed domain member by the first device.

37. The terminal of claim 36, wherein the first entity is DA/DEA and the second entity is Rights Issuer (RI)/Contents Issuer (CI).

38. The terminal of claim 36, wherein the first device includes a DRM (Digital Rights Management) agent that calculates a first verified value using first information, sends an authentication request message including the calculated first verified value to the second device, receives a second verified value included in an authentication response message from the second device, and verifies whether the second device is a properly subscribed member of the domain.

39. The terminal of claim 36, wherein the second device includes a DRM agent that receives a first verified value included in an authentication request message from the first device, verifies whether the first device is a properly subscribed domain member, calculates a second verified value using second information, and sends an authentication response message including the second verified value to the first device.

40. The terminal of claim 38, wherein the first information includes at least one of a domain ID, a first device ID, a random value and an electronic signature value of an entire message calculated using a private key of the first device.

41. The terminal of claim 39, wherein the second information includes at least one of a domain ID, a first device ID, a second device ID, a random value and an electronic signature value of an entire message calculated using a private key of the first device.
